(19) United States
(12) Patent Application Publication
(10) Pub. No.: US 2006/0008019 A1
(43) Pub. Date: Jan. 12, 2006

(54) Communications method

(76) Inventor: Nobuaki Kawahara, Nakano-ku (JP)

Correspondence Address: WENDEROTH, LIND & PONACK, L.L.P., 2033 K STREET N. W., SUITE 800, WASHINGTON, DC, 20006-1021, US

(21) Appl. No.: 10/527,020

(22) PCT Filed: Nov. 26, 2003
(86) PCT No.: PCT/JP03/15082

§ 371 Date: Mar. 8, 2005

(30) Foreign Application Priority Data
Dec. 5, 2002 (JP) 2002-353491

(51) Int. Cl. H04L 23/02

(52) U.S. Cl. 375/261

(57) ABSTRACT

The communications characteristics are improved with a communications method for carrying out communications using a plurality of M signal points to be placed on an I-Q plane. When the M signal points are spaced on the I-Q plane around a point of origin to have a uniform space a in directions of an I-axis and a Q-axis, inside of a circle or inside of the circle covering over the circle having a radius of a space b between the point of origin and a point of the largest value in both directions of the I-axis and the Q-axis, the M signal points are placed in such a manner that a space between any two arbitrary signal points is equal to or larger than the uniform space a, and a space between at least a pair of signal points is larger than the uniform space a.

### TECHNICAL FIELD

The present invention relates to communications methods and others for carrying out communications using a plurality of signal points to be placed on an I-Q plane and more specifically, to a communications method and others for improving the communications characteristics.

### BACKGROUND ART

For example, in digital mobile communications, communications is carried out often by multi-level quadrature amplitude modulation such as 32 QAM (Quadrature Amplitude Modulation) and 64 QAM, and multi-level-quadrature-amplitude demodulation therefor.

In an exemplary case of transmitting data of 9.6 kbps over a narrow bandwidth of 3 kHz, conventionally, such data transmission is generally realized by 32 QAM or 64 QAM.

FIG. 9 shows exemplary specifications of 32 QAM and 64 QAM in a case for data communications of 9.6 kbps. Therein, redundant information denotes any known pattern used for communications synchronization and waveform equalization between transmitters and receivers, and is structured as unique word (UW: Unique Word), for example.

Referring to the information amount ratio in the drawing between the redundant information and communications data (redundant information:data ratio), adopting 64 QAM is considered desirable. If adopted, however, it may cause such a problem that a minimum space between signal points (interdistance between signal points) is too narrow for using 64 QAM under the circumstances of causing non-linear distortion to occur. For betterment, conventionally, as a requirement, when any non-linear distortion occurs under the usage circumstances, 32 QAM is generally adopted, and when not, 64 QAM is generally adopted.

FIG. 10 shows an exemplary pattern for symbol mapping to be derived as a result of simple multi-valuing applied to 32 QAM. The drawing shows the general placement of signal points (symbols) with 32 QAM.

To be specific, the drawing shows an I-Q plane that is an orthogonal coordinates plane, a lateral axis of which is an I-phase component axis (I-axis) and a longitudinal axis of which is a Q-phase component axis (Q-axis). On the I-Q plane, a plurality of 32 signal points are placed. In the drawing, the signal points are indicated, respectively, by a white circle (∘) or a black circle (●).

The 32 signal points are so placed that, around a point of origin (point whose coordinate value in the direction of I-axis is 0, and coordinate value in the direction of Q-axis is 0), any two adjacent signal points are spaced uniformly in the directions of both the I-and Q-axes. Further, the placement of the signal points are symmetric to both the I- and Q-axes.

In the example of the drawing, any two signal points out of those showing the largest amplitude are used as signal points for structuring the unique word (UW), and in the drawing, such signal points are shown by the black circles.

Herein, as an exemplary conventional technology relating to the placement of signal points with QAM, the placement of signal points with 16 star QAM corresponds to the placement of signal points with two-level 8-PSK (Phase Shift Keying). The first circle includes 8 signal points, and the second circle also includes 8 signal points (as an example, refer to Patent Document 1). Note here that such a placement of signal points with 16 star QAM is different from the placement of signal points of the present invention, and for example, giving no consideration to the minimum spacing between the signal points, and resulting in higher probability of error occurrence at the time of demodulation compared with the placement of signal points of the present invention.

Patent Document 1
JP-A-8-97876

As such, when such conventional modulation schemes as 32 QAM and 64 QAM and demodulation schemes therefor are used for communications, the communications characteristics may be disadvantageously inadequate if such schemes are used under the circumstances including any source of causing non-linear distortion, for example. Thus, inconsideration of the present circumstances (conventional technology), there has been a demand for better communications quality.

Described now is such conventional problems more specifically.

FIG. 11 shows exemplary characteristics of a case where the above-described conventional placement of signal points with 32 QAM of FIG. 10 is used to carry out communications under the circumstances of including any source of causing non-linear distortion. Therein, the lateral axis denotes a signal to noise ratio (S/N:Signal to Noise Ratio) [dB ], and the longitudinal axis denotes a bit error rate (BER) (Bit Error Rate).

As shown in the drawing, under the circumstances of including any source of causing non-linear distortion, mapping with the conventional 32 QAM considerably degrades the characteristics, and concluded as not suited for data transmission.

The reason for considerably degrading the communications characteristics may be the characteristics of automatic gain control (AGC:Automatic Gain Control), and group delay due to LPF (Low Pass Filter) in receivers. Here, in some specific communications circumstances, AGC may be so exercised that the time for attack and recovery may be very short. If this is the case, with the modulation scheme provided with amplitude information, such AGC quick in motion ruins the amplitude information, causing a phenomenon of data deficit. As a result, the characteristics are accordingly degraded.

As a solution for such a phenomenon, for example, slowing the operation of AGC, or restricting the usage only in linear regions is generally known as being most effective. However, canceling out the non-linear distortion is almost impossible if the solution is handled only by modulation/demodulation means without the change of radio. Thus, generally, it is impossible to adopt any modulation scheme with the multi-value larger in number.

The present invention is proposed to solve such conventional problems, and an object thereof is to provide a communications method and others capable of improving the communications characteristics compared with the conventional technology at the time of communications using a plurality of signal points to be placed on an I-Q plane.

### DISCLOSURE OF THE INVENTION

To attain the above object, with a communications method of the present invention, a plurality of M signal points to be placed on the I-Q plane are used for communications with the following placement of signal points adopted.

More in detail, inside of a circle having the radius of a predetermined first space b, or inside of the circle covering over the circle, the M signal points are placed in such a manner that the space between any two signal points are equal to or larger than a predetermined second space a, and the space at least between a pair of signal points is larger than the predetermined second space a. Communications is carried out with such a placement of signal points. Herein, the space denotes the distance on the I-Q plane, for example.

Herein, in the case that the M signal points are spaced to have a uniform space a in both the I- and Q-axes around a point of origin on the I-Q plane (in the below, referred to as case A), the predetermined first space b is equivalent to a space b between the point of origin and a point having the largest value both in the I- and Q-axes.

The predetermined second space a is equivalent to the uniform space a.

In another case that the M signal-points are spaced to have the uniform space a in both the I- and Q-axes with the point of origin centered on the I-Q plane, such a placement is equivalent to a conventionally general placement of signal points as shown in FIG. 10 described above (exemplary 32 QAM in the drawing), for example. In this case, the uniform space a is equivalent to a space between any two signal points adjacent to each other in the I- or Q-axis in the conventional M-value QAM. Note herein that, as shown in FIG. 10 described above, with the conventional general placement of signal points, the signal points in position look, in its entirety, like a square or a partially-chipped square.

Further, as shown in FIG. 10 described above, with the conventionally general placement of signal points, for example, observed are symmetry to the I-axis, symmetry to the Q-axis, symmetry to a linear line directed in the direction of +45 degrees (=a linear line directed in the direction of −135 degrees), and symmetry to a linear line directed in the direction of +135 degrees (=a linear line in the direction of −45 degrees). Moreover, as shown in FIG. 10 described above, with the conventionally general placement of signal points, for example, the signal points are not placed on the point of origin, the I-axis, nor the Q-axis, but at four coordinates on the I-Q plane of (+a/2, +a/2), (−a/2, +a/2), (−a/2, −a/2) and (+a/2,−a/2), and based thereon, the required number of signal points are placed as if spreading out by degrees in placement region of the signal points.

Therefore, for example, using the region over a circle or the region inside of the circle having the radius of the space b between the point of origin and the point of the largest value in both the I- and Q-axes in the conventional technology, the M signal points are placed in such a manner that the space between any two arbitrary signal points is equal to or larger than the minimum space a between the signal points in the conventional technology, and the space between a pair or more of signal points is larger than the minimum space a between the signal points in the conventional technology. Accordingly, compared with the conventional technology, the communications characteristics can be improved, thereby leading to better communications quality.

Here, as to the number of signal points exemplified as M being plural, any number will be applicable, and for example, 16, 32, 64, 128, 256, and others will do.

Further, for example, the signal points are each corresponding to data that is equivalent to each different value. At the transmission end, such data is converted (modulated) into the corresponding signal point for transmission, and at the reception end, thus received signal point is converted (demodulated) into the corresponding data. As the data value, the digital value is used, for example.

Still further, in the above case A, the point of the largest value in both the I- and Q-axes denotes a point whose coordinate value in the I-axis direction is the coordinate value of the signal point having the largest coordinate value in the I-axis among the M signal points, and whose coordinate value in the Q-axis direction is the coordinate value of the signal point having the largest coordinate value in the Q-axis among the M signal points. Note here that such a point is not always found in the M signal points, and as in the above FIG. 10 case, the M signal points may not include such a point.

Still further, as the placement of including the M signal points inside of a circle or inside of the circle covering over the circle, for example, the placement of including the M signal points inside of the circle not covering over the circle is a possibility. As another possibility, the M signal points may be partially placed over the circle, and the remaining signal points may be placed inside of the circle.

Still further, as the placement in which the space between any two arbitrary signal points is equal to or large than the predetermined second space a, and the space between at least between a pair of signal points is larger than the second space a, for example, the placement in which the space between any possible pair of signal points is equal to or larger than the predetermined second space a, and the space between a pair or more of signal points is larger than the predetermined second space a is a possibility. As such, various types of placements will be applicable.

Still further, as the number of pairs having the space therebetween larger than the predetermined second space a, various numbers will be applicable as long as the number is 1 or larger. That is, the space between any possible pair of signal points is equal to or larger than the predetermined second space a, and thus the communications characteristics are not degraded compared with the conventional technology. What is more, the space between a pair or more of signal points is larger than the predetermined second space a, and thus, the communications characteristics can be better compared with the conventional technology.

Also, in the communications method of the present invention, as an exemplary structure, the M signal points are placed on a plurality of circles with a point of origin centered on the I-Q plane. Each of the circles has a radius that is an integral multiple of the radius of the smallest circle, and the radius of the largest circle is the above-described space b.

Accordingly, thanks to such a concentric placement of signal points, the region on the I-Q plane can be effectively used for placing the signal points thereon.

Here, various numbers will be applicable to the number of circles.

Further, the radius of the circle may be the same as the radius of the smallest circle, or doubled or tripled the radius thereof, for example.

Further, in the communications method of the present invention, as an exemplary structure, the signal points being the integral multiple of 4 are spaced uniformly on the corresponding circle to be symmetric with respect to both the I- and Q-axes.

Therefore, thanks to such a symmetric placement of signal points, the region on the I-Q plane can be effectively used for placing the signal points thereon.

Here, the integral multiple of 4 may be 4, 8, 12, 16, and others.

Further, uniformly spacing a plurality of signal points on a single circle means that the angle (phase) difference on the I-Q plane of any two adjacent signal points on the circle is completely equalized.

Moreover, in the communications method of the present invention, a signal point corresponding to a reception signal is converted into data corresponding to any of a plurality of M signal points to be placed on the I-Q plane in the following manner.

That is, a determination is made about the level of the signal point corresponding to the reception signal, and a determination is also made about the phase of the signal point of the reception signal on the I-Q plane. Then, the signal point of the reception signal is converted into data equivalent to the value based on such determination results (i.e., determination result about the level, and determination result about the phase).

Accordingly, using the placement of signal points of the present invention or any other possible placement of signal points, for example, by going through a simple process, the result derived by converting data to a signal point can be converted back to the original data based on the level and phase of the signal point. To be specific, realized thereby is an exemplary process for specifying the signal point of the reception signal in the M signal points, and then converting thus specified signal point to the corresponding data.

Here, to determine the level of the signal point of the reception signal, various determination manners are applicable, and for example, the level of the signal point may be uniquely determined (specified), the difference between the level of the signal point and a predetermined threshold value may be determined (compared), or others.

Moreover, to determine the phase of the signal point of the reception signal, various determination manners are applicable, and for example, the phase of the signal point may be uniquely determined (specified), the difference between the phase of the signal point and a predetermined threshold value may be determined (compared), or others.

In a communications system of the present invention, with the structure as below, signal communications is carried out from a communications device at the transmission end to a communications device at the reception end using a plurality of M signal points to be placed on the I-Q plane.

In detail, the communications device at the transmission end converts transmitting data into a signal point using such a placement of signal points as below. That is, signal point conversion means places the M signal points inside of a circle or inside of the circle covering over the circle with the radius of the space b between the point of origin and the point of the largest value in both the I- and Q-axes in the case where the M signal points are placed to have the uniform space a both in the I- and Q-axes with the point of origin centered on the I-Q plane. Therein, the space between any two arbitrary signal points is equal to or larger than the uniform space a, and the space between at least a pair of signal points is larger than the uniform space a. In the communications device at the transmission end, signal transmission means forwards a signal structured by the signal point as a result of conversion by the signal point conversion means.

Also in the communications device at the reception end, signal reception means receives the signal and signal point position determination means determines the position of the signal point of the reception signal on the I-Q plane. Still in the communications device at the reception end, data conversion means then converts the signal point of the reception signal into data corresponding to the signal point that is identified based on the determination result by the signal point position determination means.

Accordingly, by carrying out communications using such a placement of signal points, the communications characteristics can be improved for the resulting communications. As a result, realized is better communications quality.

Here, as the communications system, various types of systems are applicable such as cellular phone systems, and easy-to-carry portable phone system (PHS:Personal Handy phone System).

Further, as the communications device at the transmission end, various types will be applicable. It is not restricted to communications devices capable of only transmission, but communications devices capable of both transmission and reception may be used.

Still further, as the communications device at the reception end, various types will be applicable. It is not restricted to communications devices capable of only reception, but communications devices capable of both transmission and reception may be used.

The setting is made to the communications device at the transmission end, and/or the communications device at the reception end about the placement of signal points used for communications and the correspondence between signal points and data.

The transmitting data is not restricted in type.

The number of signal points derived as a result of conversion of transmitting data into signal points may be 1 or more.

Further, signals to be transmitted by the signal transmission means are not necessarily structured only by signal points derived as a result of converting data to be transmitted, and for example, may be those including signal points of any other information such as unique words.

Still further, to determine the position of the signal point of the reception signal on the I-Q plane, various manners will be applicable, and for example, the position of the signal point may be uniquely determined (specified), or the signal point may be determined in which region it is located out of those plurally predetermined regions. Herein, the signal point of the reception signal is specified as being the signal point locating closest out of a plurality of those being logical and used for communications.

In the below, an exemplary structure of the present invention will be shown in more detail.

In the present invention, as an exemplary structure, correspondence is established between data as a combination of:a value based on a quadrant in which a signal point is located on the I-Q plane, a value based on the level of the signal point, and a value based on the phase of the signal point on the I-Q point, and the signal point.

Here, the quadrant includes first to fourth quadrants on the I-Q plane.

Further, to combine the value based on the quadrant, the value based on the level, and the value based on the phase, for example, by presumably using data structured by a plurality of bit (bit) values in line, the line of bit values is divided into three sections, and each bit value section may be corresponded to a value based on the respective elements (quadrant, level, and phase. Here, the order is arbitrary).

Herein, shown is the exemplary structure of using the quadrant, level, and phase as the elements for specifying the value of data corresponding to the signal point. As an exemplary alternative structure, the elements may be partially used, or any other elements may be used.

In the present invention, as an exemplary structure, communications is carried out using a plurality of M signal points to be placed on the I-Q plane with the placement of signal points as below.

In detail, the M signal points are placed on a plurality of circles with a point of origin centered, and on each of the circles, the minimum value of a space between any adjacent two signal points and the minimum value of a space between signal points respectively on two different circles adjacent to each other are so set as to be both equal to or larger than a predetermined space r, and a space between at least a pair of signal points to be larger than the space r.

Here, the predetermined space r is exemplarily set in accordance with the required communications characteristics, and generally, the predetermined space r is specifically set to be larger as the required communications characteristics are good as the characteristics.

Note herein that the predetermined space r is not restricted in value.

Further, in the present invention, as an exemplary structure, a signal point of a reception signal is converted into data corresponding to any of a plurality of M signal points to be placed on the I-Q plane.

In detail, value specification is performed based on the quadrant in which the signal point of the reception signal is located on the I-Q plane, based on the level of the signal point of the reception signal, and then based on the phase of the signal point of the reception signal on the I-Q plane. Then, the signal point of the reception signal is converted into data corresponding to the resulting value combination.

Note here that shown is the exemplary structure of using the elements such as quadrant, level, and phase for converting the signal point to data corresponding thereto. As an exemplary alternative structure, the elements may be partially used, or any other elements may be used.

The present invention can be available in any other possible various structures.

To be specific, the present invention can be provided as, for example, communications devices, transmitters, receivers, communications systems, base station devices, relay devices, relay amplifiers, mobile station devices, modulators, demodulators, mapping devices, demapping devices, and others. Furthermore, the present invention can be provided in such format as devices, methods, schemes, programs, storage media, and others.

For communications, wireless communications is an option, and cable communications is also an option, or alternatively, both wireless and cable communications will do.

Moreover, relating to the above description, as an exemplary alternative structure, the space between any two arbitrary signal points may be not specifically restricted, and any other possible placement of signal points different from the conventional placement can be realized. With such a placement of signal points, for example, any new placement of signal points unlike the conventional technology can be realized for communications. Moreover, another possible placement of signal points is that, in which, the space between any possible pair of signal points may be set arbitrary, and the communications characteristics can be improved compared with the conventional technology.

### BRIEF DESCRIPTION OF THE DRAWINGS

FIG. 1 is a diagram showing an exemplary structure of a communications system of an example of the present invention.

FIG. 2 is a diagram showing exemplary symbol mapping of 32 QAM.

FIG. 3 is a diagram for comparison between the proposed example and a conventional example for the symbol mapping of 32 QAM.

FIG. 4 is a diagram for illustrating demapping.

FIG. 5 is a diagram showing an exemplary procedure of a demapping process.

FIG. 6 is a diagram for comparison between the proposed example and the conventional example for the communications characteristics.

FIG. 7 is a diagram showing exemplary symbol mapping of 64 QAM.

FIG. 8 is a diagram showing another exemplary symbol mapping of 64 QAM.

FIG. 9 is a diagram showing exemplary characteristics o 32 QAM and 64 QAM in a case of carrying out data communications of 9.6 kbps.

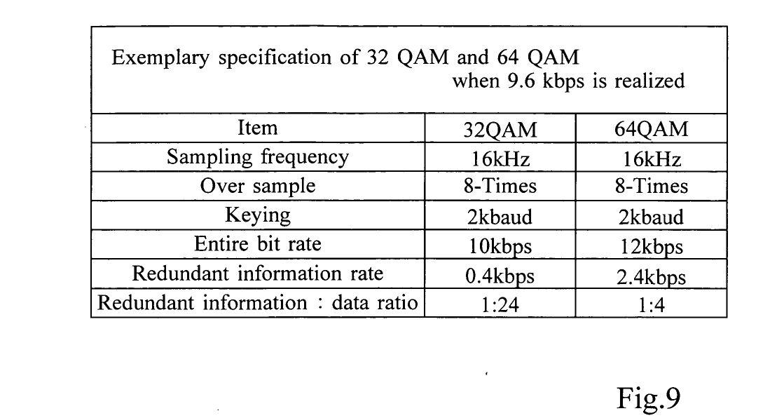

FIG. 10 is a diagram showing symbol mapping of 32 QAM of the conventional example.

FIG. 11 is a diagram showing exemplary communications characteristics in an environment including any source of causing non-linear distortion in the conventional example.

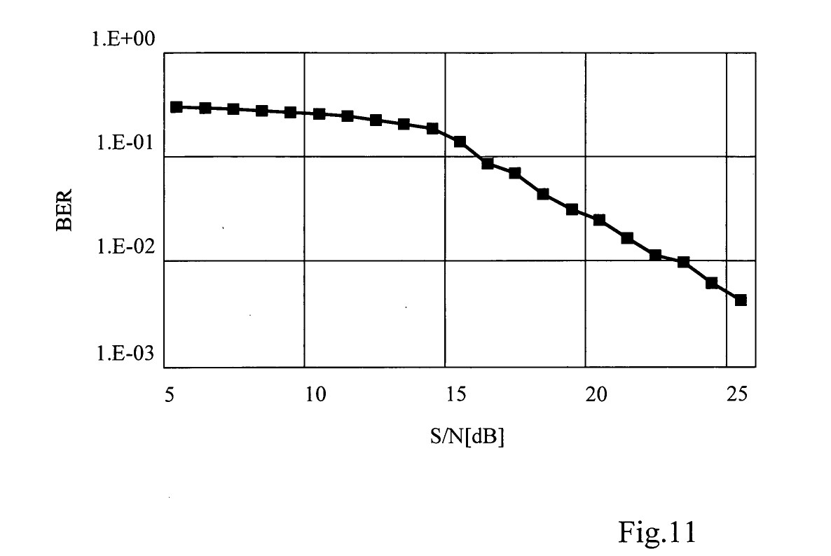

### BEST MODE FOR CARRYING OUT THE INVENTION

An example of the present invention is described by referring to the accompanying drawings.

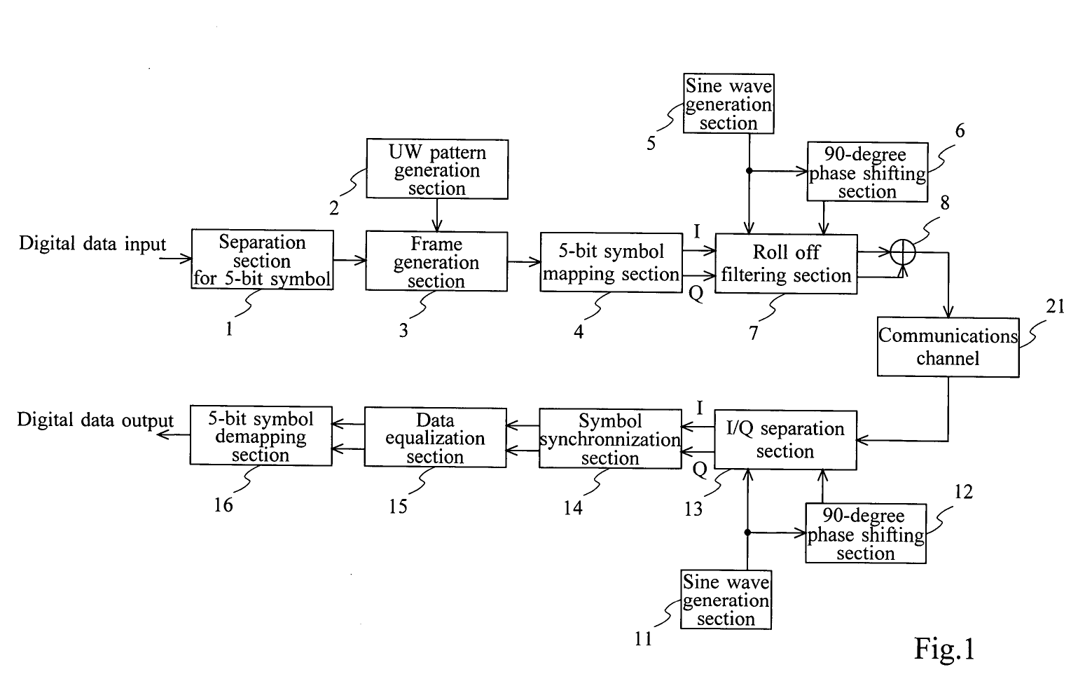

FIG. 1 shows an exemplary structure of a communications system of an example of the present invention.

The communications system of the present example is structured by connecting together, via a communications channel 21, a communications device for executing a modulation process including symbol mapping (in the below, referred to as communications device at the transmission end), and another communications device for executing a demodulation process including symbol demapping (in the below, referred to as communications device at the reception end).

The communications device at the transmission end is provided with:a symbol separation section 1; a unique word (UW) pattern generation section 2; a frame generation section 3; a symbol mapping section 4; a sine wave generation section 5; a 90-degree phase shifting section 6; a roll off filtering section 7; and an addition section 8.

The communications device at the reception end is provided with: a sine wave generation section 11; a 90-degree phase shifting section 12; an I/Q separation section 13; a symbol synchronization section 14; a data equalization section 15; and a symbol demapping section 16.

First, described is the placement of signal points to be used in the communications system of the present example.

In the present example, 32 QAM capable of representing data of 5 bits is exemplarily used for communications, and 32 QAM is exemplified for description.

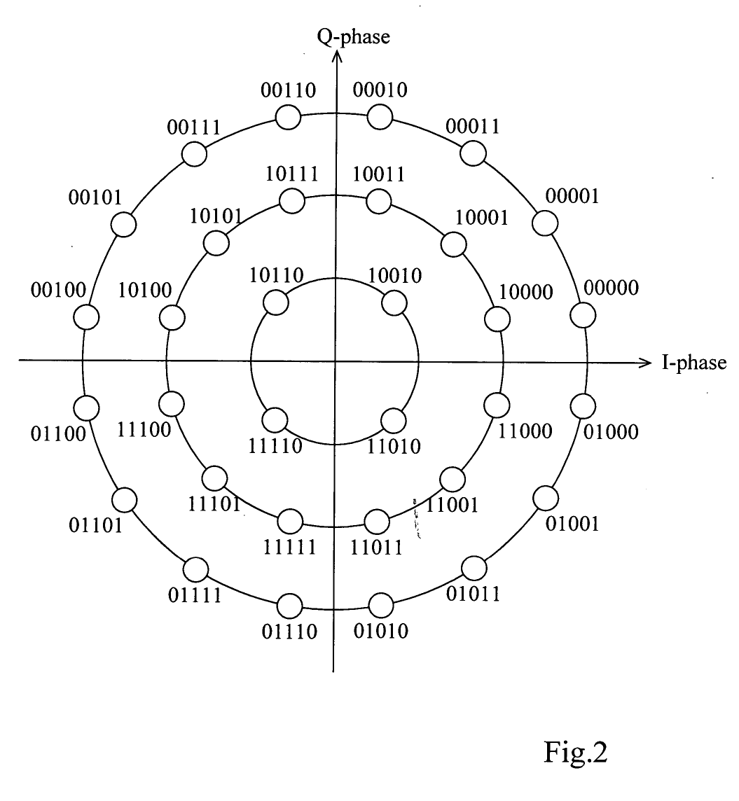

FIG. 2 shows exemplary symbol mapping with 32 QAM exemplified in the present example. On the I-Q plane with the lateral axis of an I-phase component axis (I-axis), and the longitudinal axis of a Q-phasecomponent axis (Q-axis), 32 signal points are placed (indicated by white circles (∘)).

In the present example, the basic baseband modulation scheme is applied, and as shown in the drawing, used is the placement of signal points in which mapping combination is applied to a plurality of circles, each on which (on the rim) a plurality of signal points (symbols) are placed. To be specific, in the present example, three circles are provided, and the most external circle having the largest radius (in the below, referred to as most-external circle) is provided with 16 symbols on the rim thereof. The second-external circle having the smaller radius than the most-external circle (in the below, referred to as middle circle) is provided with 12 symbols on the rim thereof, and the most-internal circle having the smaller radius than the middlecircle (in the below, referred to as most-internal circle) is provided with 4 symbols on the rim thereof.

Also, as shown in the drawing, the signal points are each corresponding to any of its own 5-bit digital data “xxxxx” (where “x” denotes a value of 1 or 0), and representing each different value.

In the present example, information about the placement of signal points shown in the drawing, and information about the correspondence between the signal points and digital data values are set to the communications device at the transmission end and the communications device at the reception end as the information of each corresponding contents exemplarily in the format of table information.

Also in the present example, the signal points locating on the rim of the most-external circuit having the largest amplitude are used to form the UW pattern. However, the signal points locating on the rim of the most-external circle are not necessarily used for the UW pattern, and any other signal points may be used for the purpose.

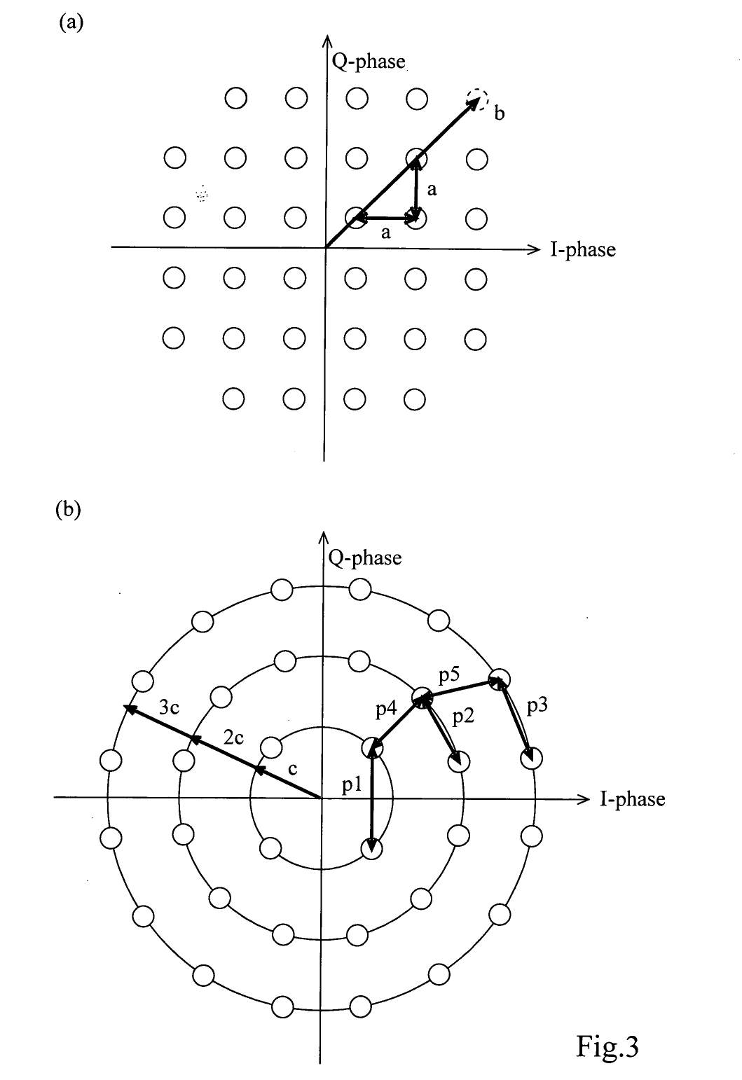

Next, by referring to FIGS. 3(a) and (b), the above described placement of signal points of the present example shown in FIG. 2 is described again in more detail.

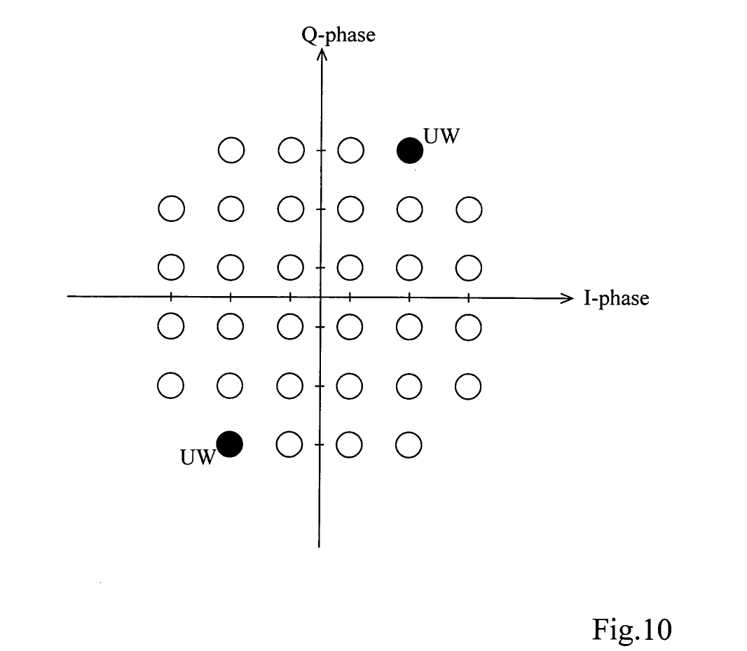

FIG. 3(a) shows the placement of signal points with 32 QAM of the conventional example shown in FIG. 10 described in the above.

FIG. 3(b) shows the placement of signal points with 32 QAM of the present example (this proposed example) shown in FIG. 2 described in the above.

First, with the conventional QAM, the maximum number of signal points to be placed in one quadrant is assumed to be p, when viewing the I-axis direction or Q-axis direction. To be specific, for example, with 32 QAM shown in FIG. 3(a), the maximum number of signal points is 3 in the quadrant when viewing the I-axis direction or the Q-axis direction. Thus, p=3, and with 16 QAM, p=2.

Conventionally, M-value QAM is realized using M signal points covering entirely or partially 4p² signal points, p of which is presumably an integer of 1 or larger, and a coordinate value in the I-axis direction i=(−p+½), {−(p−1)+½}, . . . , (−2+½), (−1+½), (1−½), (2−½) . . . ,{(p−1)−½, (p−½), and a coordinate value in the Q-axis direction q=(−p+½), {−(p−1)+½}, . . . , (−2+½), (−1+½),(1−½), (2−½) . . . , {(p−1)−½}, (p− 1/2). In this case, on the I-Q plane, assuming that the space is L between a point of origin and a point having the coordinates value (i, q)=(p−½, 0), or (0, p−½), the space between the point of origin and a point having the coordinates value of (i, q)=(p−½, p− 1/2) will be 2^{1/2}L.

Note here that the coordinates value referred to in the present example is the one provided with any values considered appropriate for convenience of description, and the same coordinates values may not be necessarily used.

In the conventional example shown in FIG. 3(a), M=32, and p=3. Moreover, assuming that a space between any two signal points adjacent to each other in the I-axis direction or the Q-axis direction is a, and a space between a point of origin and a point having the coordinates value of (i, q)=(3−½, 3−½) is b, thus L=(3−½)a, and 2^{1/2}L=b. The minimum space between signal points (interdistance between signal points) is a.

That is, in the above description, presumably, L=(p−½), and the distance between any two signal points adjacent to each other in the I-axis direction or the Q-axis direction (difference of coordinate value) is 1. When the distance is a as in the present example, L=(p−½)a, and thus, a=L/(p−½)=2L/(2p−1)={2^{1/2}b/(2p−1)}.

In the present example, the M signal points are placed inside of a circle having a radius z, or inside of the circle covering over the circle in such a manner that a space between any two arbitrary signal points is equal to or larger than {2^{1/2}z/(2p−1)}, and a space between at least a pair of signal points is larger than the {2^{1/2}z/(2p−1)}.

Herein, as an exemplary structure, when the radius z takes the minimum value in the possible range, the region on the I-Q plane can be preferably minimized to be used for placement of signal points.

In the example shown in FIG. 3(b), the above-described radius z=3c=b, and thus regions for placing the signal points therein will be fit inside of the largest amplitude b in the conventional technology. Moreover, in the present example, a most-internal circle having the radius of c, a middle circle having the radius of 2c , and a most-external circle having the radius of 3c are provided. In the placement, the minimum spaces p1, p2, and p3 between signal points on the rim of the corresponding same circle, and the minimum spaces p4 and p5 between signal points on the rims of any two adjacent circles are all set larger than the minimum space a between signal points in the conventional technology.

To be specific, in the present example, the first to fourth quadrants each include 8 signal points, and these signal points are symmetric to both the I- and Q-axes. Exemplifying the first quadrant, in the most-internal circle, the signal points are each placed in the direction of the angle (phase) of 45 degrees (°). In the middle circle, the signal points are each placed in the angle direction of 15 degrees, 45 degrees, and 75 degrees and in the most-external circle, the signal points are each placed in the angle direction of 11.25 degrees, 33.75 degrees, 56.25 degrees, and 78.75 degrees.

Described next is an exemplary operation to be executed by the communications system of the present example shown in FIG. 1 in the above.

In this example, in an attempt to realize the high-speed data communications under the narrow-band data communications environment with the data-effective frequency bandwidth of about 3 kHz, data is regarded as an aural signal for transmission using the frequency bandwidth so far conventionally used for analog audio communications.

Shown below is an exemplary operation to be executed by the communications device at the transmission end.

First, digital data to be transmitted is input to a processing system, and then input to the symbol separation section 1.

From the input digital data series, the symbol separation section 1 separates and extracts bit data of a symbol, and then outputs thus extracted bit data to the frame generation section 3. In this example, the symbol separation section 1 separates the input digital data series into a data series on the basis of 5-bit.

The UW pattern generation section 2 generates, as a UW pattern any known pattern (for example, data of 40 bits) that has been commonly set between the transmitter and receiver (transmission end and reception end), and then outputs the resulting UW pattern to the frame generation section 3.

At the head or any other position of data having a predetermined length (a frame) of the digital data series provided by the symbol separation section 1, the frame generation section 3 adds data of the UW pattern coming from the UW pattern generation section 2. Thereby, frame data is generated, and the resulting frame data is output to the symbol mapping section 4.

In accordance with any known placement of signal points (symbol mapping pattern) that has been commonly set between the transmitter and receiver, the symbol mapping section 4 converts the frame data provided by the frame generation section 3 into I-phase component data and Q-phase component data (I/Q mapping). The resulting I-phase component data and Q-phase component data are output to the roll off filtering section 7. In this example, used is the symbol mapping pattern of 32 QAM shown in FIG. 2 in the above, and the data corresponding to each of the signal points is structured by the I-phase component data of a value corresponding to the coordinate value in the I-axis direction of the signal point, and the Q-phase component data of a value corresponding to the coordinate value in the Q-axis direction of the signal point.

The sine wave generation section 5 generates a sine wave signal having the carrier center frequency used for wireless communications, and then outputs thus generated sine wave signal to both the 90-degree phase shifting section 6 and the roll off filtering section 7.

The 90-degree phase shifting section 6 shifts (phase-shifts), only by 90 degrees, the sine wave signal provided by the sine wave generation section 5, and a cosine wave signal having the carrier center frequency derived thereby is then output to the roll off filtering section 7.

The roll off filtering section 7 multiplies the I-phase component data provided by the symbol mapping section 4 and the sine wave signal provided by the sine wave generation section 5, and then subjects the multiplication result to a roll off filtering process. The result derived by the process is output to the addition section 8 as the I-phase component signal. Also, the section multiplies the Q-phase component data provided by the symbol mapping section 4 and the cosine wave signal provided by the 90-degree phase shifting section 6, and then subjects the multiplication result to the roll off filtering process. The result derived by the process is output to the addition section 8 as the Q-phase component signal.

The addition section 8 adds together the I-phase component signal and the Q-phase component signal provided by the roll off filtering section 7. The addition result is wirelessly transmitted from an antenna to the communications channel 21 as a modulation wave signal utilizing the function of the transmitter provided to the communications device at the transmission end.

The modulation wave signal wirelessly provided by the communications device at the transmission end is forwarded to the communications device at the reception end over the wireless communications channel 21, and then received by an antenna utilizing the function of the receiver provided to the communications device at the reception end.

Described below is an exemplary operation to be executed by the communications device at the reception end.

The received modulation wave signal is input to the I/Q separation section 13.

The sine wave generation section 11 generates a sine wave signal having the carrier center frequency for use by the wireless communications, and then outputs the resulting sine wave signal to both the 90-degree phase shifting section 12 and the I/Q separation section 13.

The 90-degree phase shifting section 12 shifts (phase-shifts), only by 90 degrees, the sine wave signal provided by the sine wave generation section 11, and a cosine wave signal having the carrier center frequency derived thereby is then output to the I/Q separation section 13.

The I/Q separation section 13 multiplies the modulation wave signal that has been received and input and the sine wave signal provided by the sine wave generation section 11, and then subjects the multiplication result to the roll off filtering process. The result derived by the process is output to the symbol synchronization section 14 as the I-phase component signal data. Also, the section multiplies the modulation wave signal and the cosine wave signal provided by the 90-degree phase shifting section 12, and then subjects the multiplication result to the roll off filtering process. The result derived by the process is output to the symbol synchronization section 14 as the Q-phase component signal data.

The symbol synchronization section 14 acquires, from the I/Q separation section 13, frame data structured by the I-phase component data, and frame data structured by the Q-phase component data. For every frame, for example, the position (timing) of the UW pattern is detected by going through a correlation operation process, and a process for searching for the maximum correlation value so as to detect the timing for symbol synchronization. Then, in accordance with the detected symbol synchronization, the received frame data of the I-phase component and the received frame data of the Q-phase component are output to the data equalization section 15.

The data equalization section 15 estimates and sets an equalization coefficient through training based on the position of the UW pattern detected by the symbol synchronization section 14. Then using the equalization coefficient, from each of the received frame data of the I-phase component and the received data of the Q-phase component provided by the symbol synchronization section 14, any phase distortion component and any amplitude distortion component are removed. After such distortion removal (after equalization), the received frame data of the I-phase component and the received frame data of the Q-phase component are output to the symbol demapping section 16.

Note that, in the present example, prior to equalization by the data equalization section 15, compensation is applied to any phase shifting occurring to the received data in the following manner.

That is, for compensation, based on the UW patterns found before and after the target data part, the phase shifting amounts at the positions of the UW patterns are each calculated, and then using thus calculated phase shifting amounts, the phase shifting value at the position therebetween is interpolated. In this manner, the phase shifting amount is estimated for every symbol included in the data part, and the complex conjugates of the phase shifting amounts estimated for every symbol are multiplied by the data for every symbol. Thereby, the phase shifting is compensated for every symbol included in the data part.

In accordance with the placement of signal points (symbol mapping pattern) that has been known and commonly set between the transmitter and receiver, the symbol demapping section 16 converts (I/Q demapping) the received frame data of the I-phase component and the received frame data of the Q-phase component provided by the data equalization section 15 into bit data holding the number of bits corresponding to every symbol. The resulting bit data series is then output on a bit basis as digital data. In this example, used is the symbol mapping pattern of 32 QAM shown in FIG. 2 in the above, and identification is made to see to which signal point the combination (coordinates value) of the I-phase component and the Q-phase component structuring each of the received symbols corresponds. Then, the respective symbols are converted into 5-bit digital data corresponding to the identified signal point.

Next, the demapping process to be executed by the communications device at the reception end is described in detail.

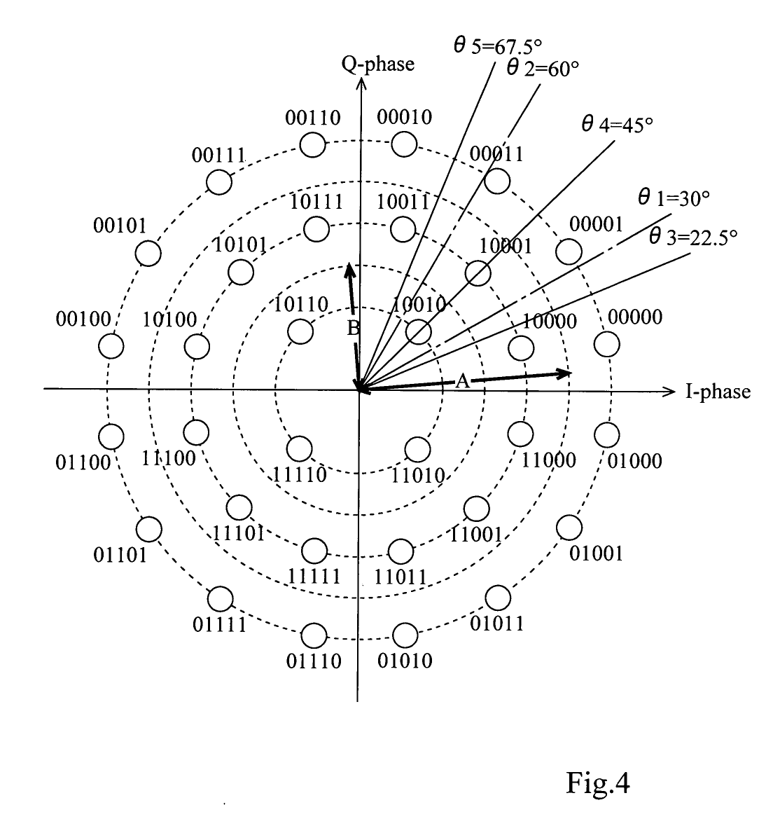

FIG. 4 shows the placement of signal points of 32 QAM of this example shown in FIG. 2 in the above, and the spaces (distances) A and B, and angles (phases) θ1 to θ5 for use in the demapping process of this example.

To be specific, the space A corresponds to the radius of a circle locating between the most-external circle and the middle circle, and in the present example, A=(2+½)c. The space B corresponds to the radius of a circle locating between the middle circle and the most internal circle, and in the present example, B=(1+½)c.

Further, the angles θ1 and θ2 are each corresponding to the angle at the middle position between any two adjacent signal points out of three of those placed on the rim of the middle circle in the first quadrant, and in this example, the angle θ1=30 degrees, and the angle θ2=60 degrees.

Moreover, the angles θ3 to θ5 are each corresponding to the angle at the middle position between any two adjacent signal points out of four of those placed on the rim of the most-external circle in the first quadrant, and in this example, the angle θ3=22.5 degrees, the angle θ4=45 degrees, and the angle θ5=67.5 degrees.

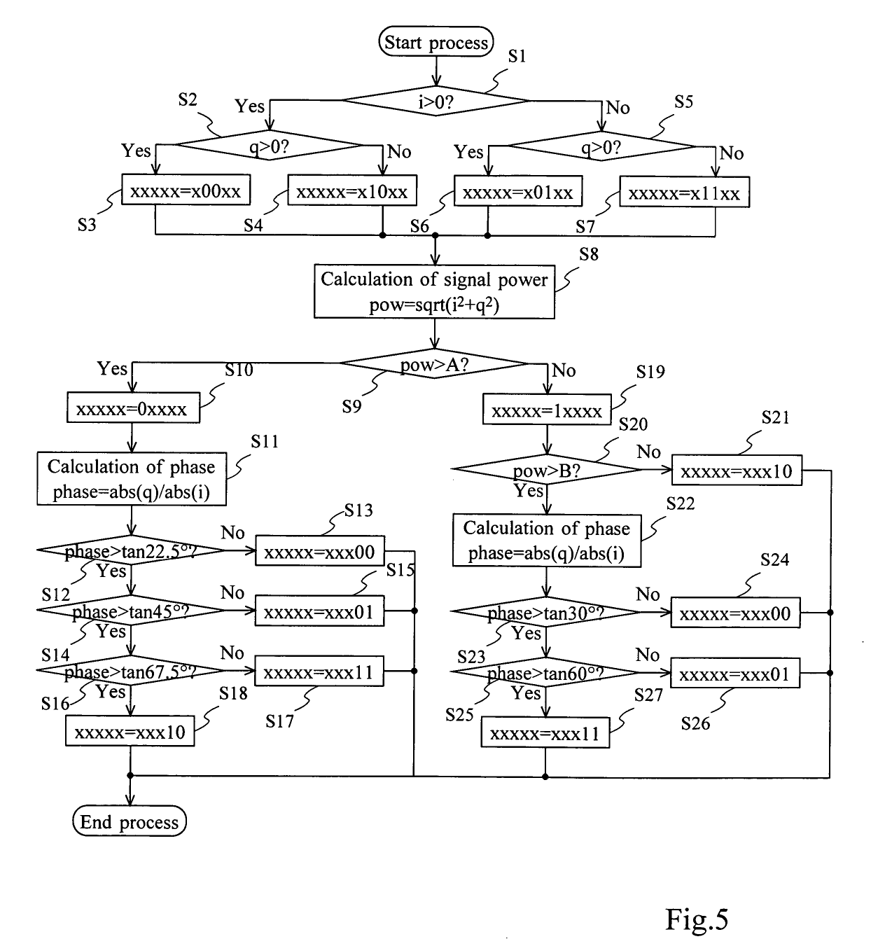

Referring to FIG. 5, an exemplary procedure of the demapping process of the present example is described.

In this example, the received signal point having the I-phase component data value is i and the Q-phase component data value is q is converted into its corresponding 5-bit digital data “xxxxx”. Here, “x” denotes a value of 0 or 1, that is, represents 1-bit data.

First, a determination is made whether i is positive or negative, and another determination is made whether q is positive or negative. Such determinations are made to identify in which quadrant the coordinates value (i, q) is found on the I-Q plane, and whereby bit value specification is done to the parts corresponding to the respective quadrants (steps S1 to S7). Note here that there is no specific restriction for which quadrant with i=0, or q=0, and the same process as in the present example is not necessarily executed.

To be specific, when i>0 (step S1), and when q>0 (step S2), the identification is made as the coordinate value being in the first quadrant. Accordingly, the second and third bit values of higher order are specified as being “00”, that is, the digital data is specified as being “x00xx” (step S3).

Similarly, when i>0 (step S1), and when q≦0 (step S2), the identification is made as the coordinate value being in the fourth quadrant. Accordingly, the second and third bit values of higher order are specified as being “10”, that is, the digital data is specified as being “x10xx” (step S4).

Also, when i≦0 (step S1), and when q>0 (step S5), the identification is made as the coordinate value being in the second quadrant. Accordingly, the second and third bit values of higher order are specified as being “01”, that is, the digital data is specified as being “x01xx” (step S6).

Moreover, when i≦0 (step S1), and when q≦0 (step S5), the identification is made as the coordinate value being in the third quadrant. Accordingly, the second and third bit values of higher order are specified as being “11”, that is, the digital data is specified as being “x11xx” (step S7).

Next, a signal power pow is calculated for the received signal point with the coordinates value of (i, q) (step S8), and then a determination is made whether the resulting signal power pow is larger than the space A of FIG. 4 in the above (step S9). At the time of this determination-making, the space A is used as a threshold value to identify whether the received signal point is locating on the rim of the most-external circle, or on the rim of the middle circle or the most-internal circle. Here, in this example, the signal power pow is pow={ (i²+q² )}^{1/2}. In the drawing, “sqrt” denotes the square root. Note here that there is no specific restriction for identifying which circle when the signal power pow=A, and the same process as in the present example is not necessarily executed.

To be specific, as a result of this determination (step S9), when the signal power pow>A, the signal point is specified as locating on the rim of the most-external circle, and the first bit value of higher order is specified as being “0”, that is, the digital data is specified as being “0xxxx” (step S10).

On the other hand, when the signal power pow≦A (step S9), the signal point is specified as locating on the rim of the middle circle or the most-internal circle, and the first bit value of higher order is specified as being “1”, that is, the digital data is specified as being “1xxxx” (step S19). Then, another determination is made whether or not the signal power pow is larger than the space B of FIG. 4 in the above (step S20). At the time of this determination-making, the space B is used as a threshold value to identify whether the received signal point is locating on the rim of the middle circle, or on the rim of the most-internal circle. Note here that there is no specific restriction for identifying which circle when the signal power pow=B, and the same process as in the present example is not necessarily executed.

To be specific, as a result of this determination (step S20), when the signal power pow≦B, the signal point is determined as locating on the rim of the most-internal circle, and the fourth and fifth bit values of higher order are specified as being “10”, that is, the digital data is specified as being “xxx10” (step S21). In such a manner, the signal points locating on the rim of the most-internal circle are all specified by the 5-bit value.

Next, as to the signal points locating on the rim of the most-external circle and the signal points locating on the rim of the middle circle, a determination is made based on the phase phase on the I-Q plane. In the present example, the phase phase is phase=|q|/|i|(where ∥ denotes the absolute value (“abs”)).

In detail, as to the most-external circle, the phase phase is calculated for the received signal point (step S11), and the resulting phase phase is then determined whether or not being larger than tan (θ3) (step S12). Here, tan (θ3=22.5 degrees) is about 0.41421.

As a result of this determination (step S12), when the phase phase≦tan (θ3), the fourth and fifth bit values of higher order are specified as being “00”, that is, the digital data is specified as being “xxx00” (step S13).

When the phase phase>tan (θ3) (step S12), the phase phase is then determined whether or not being larger than tan (θ4) (step S14). In this case, tan (θ4=45 degrees) is about 1.0000.

As a result of this determination (step S14), when the phase phase≦tan (θ4), the fourth and fifth bit values of higher order are specified as being “01”, that is, the digital data is specified as being “xxx01” (step S15).

On the other hand, when the phase phase>tan (θ4) (step S14), the phase phase is then determined whether or not being larger than tan (θ5) (step S16). In this case, tan (θ5=67.5 degrees) is about 2.4142.

As a result of this determination (step S16), when the phase phase≦tan (θ5), the fourth and fifth bit values of higher order are specified as being “11”, that is, the digital data is specified as being “xxx11” (step S17).

On the other hand, when the phase phase>tan (θ5) (step S16), the fourth and fifth bit values of higher order are specified as being “10”, that is, the digital data is specified as being “xxx10” (step S18). In such a manner, the signal points locating on the rim of the most-external circle are all specified by the 5-bit value. Note here that there is no specific restriction for identifying which signal point when the phase phase=θ (θ=θ3, θ4, and θ5), and the same process as in the present example is not necessarily executed.

As to the middle circle, the phase phase is calculated for the received signal point (step S22), and the resulting phase phase is then determined whether or not being larger than tan (θ1) (step S23). Here, tan (θ1=30 degrees) is about 0.57735.

As a result of this determination (step S23), when the phase phase≦tan (θ1), the fourth and fifth bit values of higher order are specified as being “00”, that is, the digital data is specified as being “xxx00” (step S24).

On the other hand, when the phase phase>tan (θ1) (step S23), the phase phase is then determined whether or not being larger than tan (θ2) (step S25). Here, tan (θ2=60 degrees) is about 1.73205.

As a result of this determination (step S25), when the phase phase>tan (θ2), the fourth and fifth bit values of higher order are specified as being “01”, that is, the digital data is specified as being “xxx01” (step S26).

On the other hand, when the phase phase>tan (θ2) (step S25), the fourth and fifth bit values of higher order are specified as being “11”, that is, the digital data is specified as being “xxx11” (step S27). In such a manner, the signal points locating on the rim of the middle circle are all specified by the 5-bit value. Note here that there is no specific restriction for identifying which signal point when the phase phase=θ (θ=θ1, and θ2) and the same process as in the present example is not necessarily executed.

Here, in this example, the second and third bit values of higher order in the 5-bit digital data are the values based on quadrants, and the first bit value of higher order is the value based on the level of the signal power pow. Moreover, as to the most-internal circle, the fourth and fifth bit values of higher order are the values based on the level of the power pow, and as to the middle and most-internal circles, the fourth and fifth bit values are the values based on the phase.

In the present example, as shown in FIGS. 2 and 4 in the above, the absolute value of a value of I/Q is used as a basis for placement in which the specific bits (target bits) structuring the digital data have the same value. With such a placement, as described above by referring to FIG. 5, the computation load of the demapping process can be reduced for a considerable degree. What is more, generally, for placement of signal points, it is preferable to perform placement in such a manner as to have one bit difference between data corresponding to any two signal points adjacent to each other as can as possible. If such a placement is derived, it becomes possible to suppress the degradation of the characteristics as much as possible. The placement of signal points in this example is set in consideration of the processing load of computation and others to be performed in communications by radio, distortion to be occurred in communications by radio, and required communications characteristics, for example.

The demapping process is not restricted to the process exemplified in this example, and any other possible process will do.

As an example, the demapping process may be executed by going through two-step processing procedure in the following manner.

That is, first, the power pow is calculated for the received signal point to classify the received signal point into three power levels (maximum level, medium level, and minimum level) corresponding to three circles. Then, as to the signal point classified into the maximum level is allocated into any of 16 signal points based on the phase thereof so that the digital data is confirmed. As to the signal point classified into the medium level is allocated into any of 12 signal points based on the phase thereof so that the digital data is confirmed. As to the signal point classified into the minimum level is allocated into any of 4 signal points based on the phase thereof so that the digital data is confirmed.

Next, the effects exemplarily derived by the communications system in this example are described specifically.

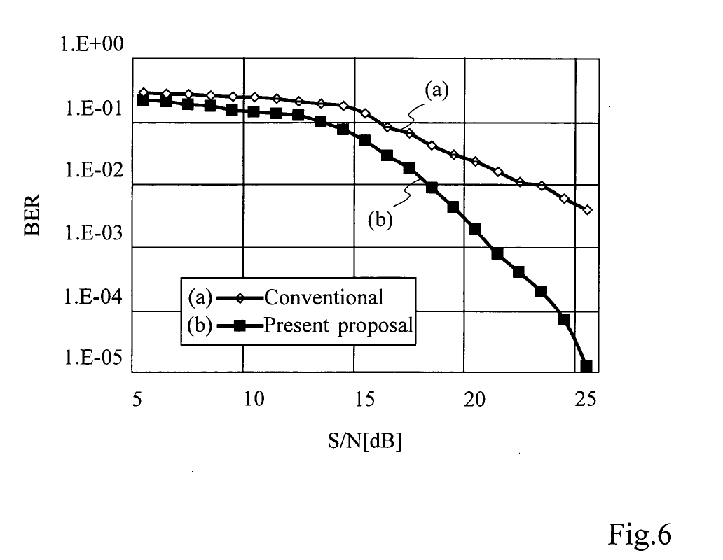

FIG. 6 shows exemplary characteristics observed at the time of communications carried out under the environment including any source of causing non-linear distortion, the environment of which is the same for 32 QAM with the placement of signal points of this example (this proposed example) shown in FIG. 2 in the above, and 32 QAM with the placement of signal points of the conventional example shown in FIG. 10 in the above. Therein, the lateral axis denotes a signal to noise ratio (S/N) [dB], and the longitudinal axis denotes a bit error rate (BER).

Further, in FIG. 6, the characteristics of the conventional example are indicated by (a), and the characteristics of this example are indicated by (b).

As shown in the drawing, compared with the conventional placement of signal points, the placement of signal points of the present example can derive better characteristics also under the environment including any source of causing non-linear distortion.

Next, an exemplary placement of signal points for QAM other than 32 QAM is shown. Herein, the detailed manner for the placement of signal points is the same as that for the placement of signal points with 32 QAM in this example shown in FIG. 2 above, and thus only a simple description is given here. Note that, other than the example to be mentioned herein, any other placements of signal points are possible for multi-value QAMs varying in value in the similar manner in this

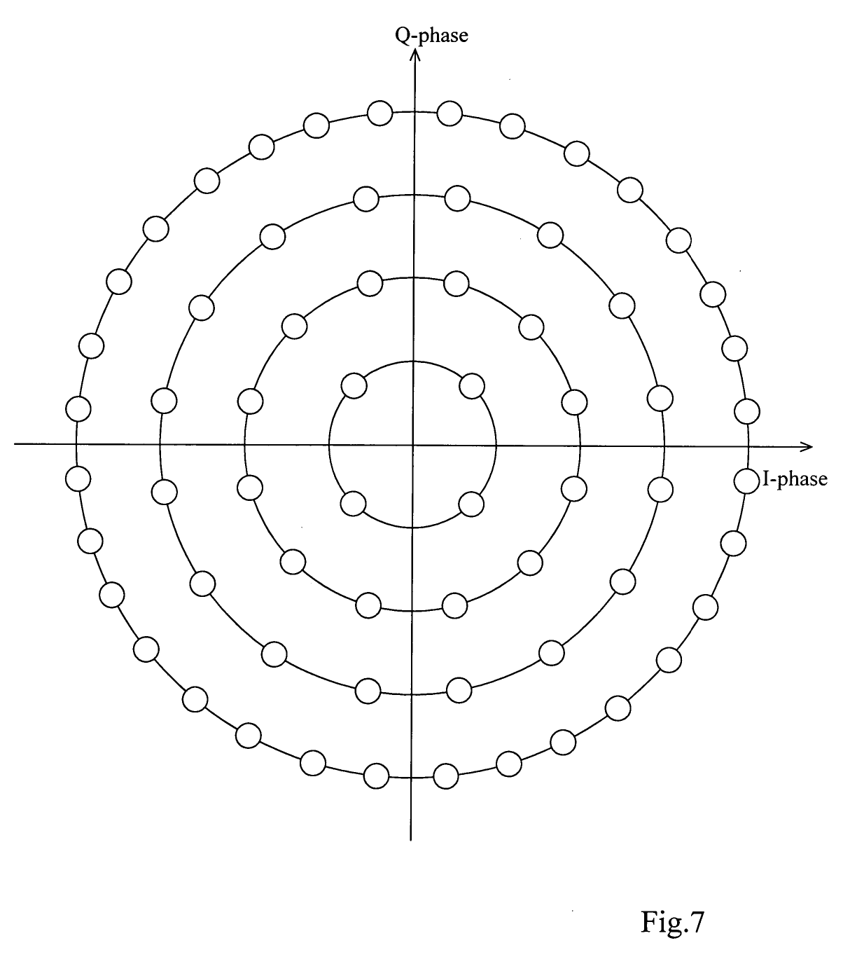

FIG. 7 shows an exemplary symbol mapping of 64 QAM in the case of applying the present invention. On the I-Q plane with the lateral axis of an I-phase component axis (I-axis), and the longitudinal axis of a Q-phase component axis (Q-axis), 64 signal points are placed (indicated by white circles (∘)).

In the example of the drawing, provided are four circles each have a radius that is an integral multiple around a point of origin, and in order of the circles having the smaller radius, 4 signal points, 12 signal points, 16 signal points, and 32 signal points are spaced uniformly on the rim of the corresponding circle symmetrically to both the I- and Q-axes.

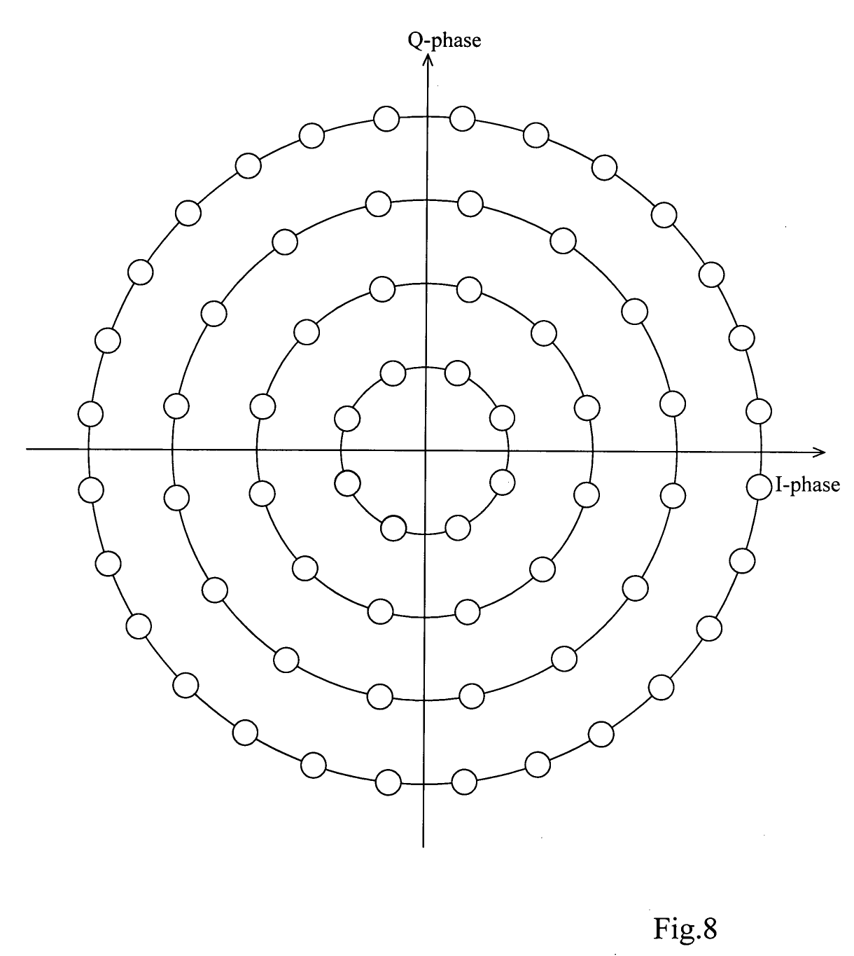

Furthermore, FIG. 8 shows another exemplary symbol mapping of 64 QAM in the case of applying the present invention. On the I-Q plane with the lateral axis of an I-phase component axis (I-axis), and the longitudinal axis of a Q-phase component axis (Q-axis), 64 signal points are placed (indicated by white circles (∘)).

In the example of the drawing, provided are four circles each have a radius that is an integral multiple around the point of origin, and in order of the circles having the smaller radius, 8 signal points, 12 signal points, 16 signal points, and 28 signal points are spaced uniformly on the rim of the corresponding circle symmetrically to both the I- and Q-axes.

As to 128 QAM, as an example, the following placements of signal points of (1) to (5) are possible

(1) Five circles are provided, and in order of the circles having the smaller radius, 4 signal points, 12 signal points, 16 signal points, 32 signal points, and 64 signal points are placed on the rim of the corresponding circle.

(2) Five circles are provided, and in order of the circles having the smaller radius, 8 signal points, 12 signal points, 16 signal points, 32 signal points, and 60 signal points are placed on the rim of the corresponding circle.

(3) Six circles are provided, and in order of the circles having the smaller radius, 4 signal points, 12 signal points, 16 signal points, 32 signal points, 32 signal points, and 32 signal points are placed on the rim of the corresponding circle.

(4) Six circles are provided, and in order of the circles having the smaller radius, 8 signal points, 12 signal points, 16 signal points, 28 signal points, 32 signal points, and 32 signal points are placed on the rim of the corresponding circle.

(5) Six circles are provided, and in order of the circles having the smaller radius, 8 signal points, 12 signal points, 16 signal points, 32 signal points, 28 signal points, and 32 signal points are placed on the rim of the corresponding circle.

As described in the foregoing, with the communications system and communications method for carrying out communications using the placement of signal points of the present example, by efficiently utilizing the symbol mapping space using the concentric placement of signal points, the minimum space between signal points (interdistance between signal points) can be ensured to be larger, for example, compared with the conventional placement of signal points.

Accordingly, with the communications system and communications method of the present example, even in a case where the signal points on the I-Q plane are degraded due to the non-linear distortion occurring at the time of communications, the strength is ensured for the non-linear distortion. Thus, communications can be carried out with better characteristics, thereby leading to communications with better quality. With better communications quality, for example, it becomes possible to enhance the communications speed, and the transmitting data can be increased in capacity.

As a specific example, with the communications system and communications method of the present example, realized are multi-value modulation and demodulation therefor with which the data transmission speed can remain high even in the narrow bandwidth, and any non-linear distortion can be dealt with even if occurred. Even in an exemplary case of performing digital data communications using the narrow bandwidth having the effective bandwidth of about 3 kHz in digital mobile communications, the data communications can remain high in speed, and the transmission-reception characteristics can be improved.

Moreover, with the placement of signal points of the present example, a relatively large number of signal points are placed on the rim of the most-external circle, that is, a relatively large number of signal points are placed at the positions showing the relatively larger amplitude. Thus, for example, it becomes possible to efficiently use the amplitude available in the limited symbol mapping space, and in such a respect, the efficient use of power can be achieved.

Further, as an example, the communications system and communications method of the present example can be structured by applying the following changes partially or entirely to the communications device of a conventional type.

To be specific, applied are a change of replacing the table of the conventional symbol mapping with the table of the symbol mapping of this example for the transmission and reception ends, a change of replacing the procedure of the demapping process with any procedure considered appropriate to the present example as to the reception end (demodulation end), and a change of replacing a slicer process at the time of equalizer tracking at the reception end with any procedure considered appropriate to the present example.

Herein, at the time of equalizer tracking, for example, a predetermined algorithm is used to execute the process of tracking data phase and delay. Further, in the equalizer slicer process, executed is a process of data separation using the number of bits corresponding to a symbol as a process unit, for example.

Still further, compared with the conventional placement of signal points, the placement of signal points of the present example can be sufficiently put into practical use in view of the computation load. For example, compared with conventional 32 QAM, although the computation load is slightly increased, 32 QAM of this example can be sufficiently put into practical use.

In the communications device at the transmission end of this example, signal point conversion means is structured by the function of converting any transmitting data into signal points on the I-Q plane by the symbol mapping section 4 and others. And therein, signal transmission means is structured by the function of transmitting signals structured by the signal points by the transmitter.

Moreover, In the communications device at the reception end of this example, signal reception means is structured by the function of signal reception by the receiver, and signal point position determination means is structured by the function of determining the position of the signal point of the received signal on the I-Q plane by the symbol demapping section 16 and others based on the quadrant, the power level, and the phase. Based on the determination result, data conversion means is structured by the function of converting the signal point of the received signal into data by the symbol-demapping section 16.

Here, the structure and manner of the present invention are not restricted to those described in the above, and various others are applicable.

Further, the field applying the present invention is not restricted to those described above, and is applicable to various other fields.

Further, as to various processes executed relating to the present invention, the structure is a possibility for exercising control by a processor executing a control program stored in ROM (Read Only Memory) in the hardware resources including the processor, memory, and others, or the structure may be used as a hardware circuit separately including the respective function means for executing such processes.

Still further, the present invention can be understood as a computer-readable recording medium such as floppy (trademark) disks, CD (Compact Disk) -ROM, and others storing the above-described control program, and the program (itself). The control program is input from the storage medium to the computer to make the processor execute the program, whereby the processes relating to the present invention can be through.

### INDUSTRIAL APPLICABILITY

As described in the foregoing, according to the communications method and others of the present invention, at the time of carrying out communications using a plurality of M signal points to be placed on the I-Q plane, the M signal points are placed to have a uniform space a in the I-axis and Q-axis directions around a point of origin on the I-Q plane. In this case, inside of a circle or inside of the circle covering over the circle having the radius of a space b between the point of origin and the point of the largest value in both the I- and Q-axes, the M signal points are placed in such a manner that the space between any two arbitrary signal points is equal to or larger than the uniform space a, and the space between at least a pair of signal points is larger than the uniform space a. Accordingly, compared with the conventional technology, the communications characteristics can be improved.

1. A communications method for carrying out communications using a plurality of M signal points to be placed on an I-Q plane, characterized in that
when the M signal points are spaced on t he I-Q plane around a point of origin to have a uniform space a in directions of an I-axis and a Q-axis, inside of a circle or inside of the circle covering over the circle having a radius of a space b between the point of origin and a point of the largest value in both directions of the I-axis and the Q-axis, the M signal points are placed in such a manner that a space between any two arbitrary signal points is equal too larger than the uniform space a, and a space between at least a pair of signal points is larger than the uniform space a.

2. The communications method according to claim 1, characterized-in that
the M signal points are placed over a plurality of circles on the I-Q plane around the point of origin, a radius of the respective circles is an integral multiple of a radius of the smallest circle, and the radius of the largest circle is the space b.

3. The communications method according to claim 2, characterized in that
on the respective circles, the signal points of the integral multiple of 4 are spaced uniformly to be symmetric to the I-axis and the Q-axis.

4. A communications method for converting a signal point of a received signal into data corresponding to any of a plurality of M signal points to be placed on an I-Q plane, characterized in that
a determination is made for a level of the signal point of the received signal, and another determination is made for a phase of the signal point of the received signal on the I-Q plane, and the signal point of the received signal is converted into data equivalent to a value based on determination results.

5. A communications system for carrying out signal communications from a communications device at a transmission end to a communications device at a reception end using a plurality of M signal points to be placed on an I-Q plane, characterized in that
the communications device at the transmission end comprises:signal point conversion means for converting transmitting data into a signal point using a placement of signal points in which, when the M signal points are spaced on the I-Q plane around a point of origin to have a uniform space a in directions of an I-axis and a Q-axis, inside of a circle or inside of the circle covering over the circle having a radius of a space b between the point of origin and a point of the largest value in both directions of the I-axis and the Q-axis, the M signal points are placed in such a manner that a space between any two arbitrary signal points is equal to or larger than the uniform space a, and a space between at least a pair of signal points is larger than the uniform space a; and
signal transmission means for transmitting a signal structured by the signal point as a result of conversion by the signal point conversion means, and
the communications device at the reception end comprises: signal reception means for signal reception;
signal point position determination means for making a determination for a position of the signal point of the received signal on the I-Q plane; and
data conversion means for converting the signal point of the received signal into data corresponding to a signal point to be identified based on a determination result by the signal point determination means.
